(19) United States
(12) Patent Application Publication
(10) Pub. No.: US 2018/0314497 A1
(43) Pub. Date: Nov. 1, 2018

(54) TRANSLATION OF ASSEMBLER LANGUAGE CODE USING INTERMEDIARY TECHNICAL RULES LANGUAGE (TRL)

(71) Applicants: Jian Wang, Sterling, VA (US); Zhenqiang Yu, Rockville, MD (US); Yan Cheng, Great Falls, VA (US)

(72) Inventors: Jian Wang, Sterling, VA (US); Zhenqiang Yu, Rockville, MD (US); Yan Cheng, Great Falls, VA (US)

(21) Appl. No.: 15/582,612

(22) Filed: Apr. 29, 2017

(51) Int. Cl. G06F 9/44; G06F 9/45

(52) U.S. Cl. CPC G06F 8/31; G06F 8/41

(57) ABSTRACT

The present invention is a TRL Engine based validation methodology which also allows validation at any level of granularity required from the application/run level all the way down to the individual line of code, which is utilized for unit testing as well as system testing.

### CROSS-REFERENCE TO RELATED APPLICATIONS

This patent application incorporates by reference herein in its entirety U.S. Provisional Application No. 62/445,188, filed Jan. 11 2017.

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention relates to the field of programming languages and more specifically to a method for translating assembler code languages.

### BACKGROUND OF THE INVENTION

Co-pending U.S. patent application No. 62/445,188 teaches a method for translation of assembler language code to a validated object-oriented programming language. TRL is a very simple high-level structured language with a minimum set of features sufficient to describe Individual Master File (IMF) Assembler Language Code (ALC) in Java. For users with only an ALC background, learning TRL is easier than learning Java. Likewise, users with Java background will find learning TRL to be easier than learning ALC.

TRL serves as a technology platform to support discover-and-translate activities during ALC to Java translation processes. TRL minimizes language features that are needed for the translation in order to reduce the complexity of the intermediary language.

There are several problems known in the art with respect to translation of ALC and other assembler code to object oriented programming languages such as Java. ALC syntax does not contain modern coding conventions such as if-then-else statements and for/while-loop statements often found in modern programming languages; which makes ALC difficult to understand and maintain by non-ALC experts.

ALC is a stackless language with flow control implemented through the use of branch and GOTO statements forming what is often refer to as “spaghetti code.” ALC allows for self-modifying code which is not used in modern programming languages of Java. TRL allows for the conversion ALC constructs into a high-level structured language, such as Java.

It is a problem known in the art that Assembler Language (ALC) programs may contain many anomalies that must be fixed before it can be accurately translated to a Technical Rules Language (TRL) in an automated fashion. Among these anomalies are unsupported ALC operands notations, unconventional use of self-modifying code (SMC), intentional or unintentional branches to non-executable data (e.g., branch to an address containing 0x00), and unconventional practice of function calls.

The TRL Engine based validation methodology also allows validation at any level of granularity required from the application/run level all the way down to the individual line of code, which is utilized for unit testing as well as system testing.

### BRIEF SUMMARY OF THE INVENTION

The present invention TRL Engine based validation methodology also allows validation at any level of granularity required from the application/run level all the way down to the individual line of code, which is utilized for unit testing as well as system testing.

### BRIEF DESCRIPTION OF SEVERAL VIEWS OF THE DRAWING(S)

FIG. 1 is a flow chart of an exemplary TRL implementation method.

FIG. 2 is a schematic of an exemplary TRL Engine.

FIG. 3 is an exemplary TRL code segment showing TRL grammar.

FIG. 4 is an exemplary TRL method with subroutines.

FIG. 5 is an illustration of how ALC instructions are mapped to TRL

FIG. 6 is a conceptual illustration of TRL translation to Java Code,

FIG. 7 is Class Diagram illustrating TRL to Java Translation.

FIG. 8 is a diagram of a TRL to Java Class Multiple Thread Model.

### TERMS OF ART

As used herein, the term “Assembler Language Code (ALC)” means a low-level programming language for a computer, or other programmable device, in which there is a very strong (generally one-to-one) correspondence between the language and the architecture's machine code instructions. Each assembly language is specific to a particular computer architecture.

As used herein, the term “Analyzer Tool” means a set of functions to analyze a run of ALC and provide information about the code including but not limited to subroutines, self-modified code, and certain patterns.

As used herein, the term “block” or “run” means a section of ALC which has been isolated for processing, which may or may not be functionally related in some manner.

As used herein, the term “Configuration Files” means files which contain=Analyzer Tool and SME inputs.

As used herein, the term “Control Flow Graph (CFG)” means a graphical representation of how instructions or function calls of an imperative program are executed or evaluated.

As used herein, the term “Data Extraction Tool” means one or more functions which parse and scan the source ALC for lines of code that contain schema information about how data variables are defined and how the data is stored in physical memory.

As used herein, the term “data” includes data values and schema.

As used herein, the term “dump” or “memory dump” means a set of data used for analysis and/or verification, a process in which the contents of memory are displayed and stored.

As used herein, the term “Individual Master File (IMF)” means an ALC application that receives data from multiple sources.

As used herein, the term “Java Data Objects” means objects generated by the Data Extraction Tool which contain data necessary in a runtime environment.

As used herein, the term “Java Object Model (JOM)” refers to a multi-layered data structure which stores information derived from ALC schema about how data is stored in ALC physical memory. The Java Object Model (JOM) may be used to execute translated code and to trace the translated code back to the legacy ALC.

As used herein, the term “Java Runtime Environment” means a software package that contains what is required to run a Java program.

As used herein, the term “legacy language” means ALC or any language specific to a particular operating system which must be translated to an object-oriented programming language or another target language.

As used herein, the term “normalizing” means any process of conforming schema and logic within a programming language to any rule or standard, e.g., in furtherance of translation from one language to another.

As used herein, the term “rule(s) engine” means software to infer consequences or perform functions based on conditions or facts. There are also examples of probabilistic rule engines, including Pei Wang's non-axiomatic reasoning system, and probabilistic logic networks.

As used herein, the term “schema” means a description of the attributes and location of data.

As used herein, the term “self-modifying code” means code that alters its own instructions while it is executing, in which the self-modification is intentional.

As used herein, the term “sequential file format” means a set of logical sequential instructions.

As used herein, the term “SME” or “subject matter expert” means humans with training to perform verification and analysis, or to modify a computer program.

As used herein, the term “target language” means a language to which legacy code is translated.

As used herein, the term “Technical Rule Language (TRL)” means a script/procedure language specially designed to capture ALC constructs and provide a separation between ALC data and program flows, and to provide limited Java functions and class definitions to facilitate translation.

As used herein, the term “Tool” means a group of two or more related functions.

As used herein, the term “Translator Tool” means a group of functions to convert ALC execution logic into TRL using pattern recognition or configuration rules.

As used herein, the term “TRL/Java Engine” means a computer processor for executing Java code.

### DETAILED DESCRIPTION OF THE INVENTION

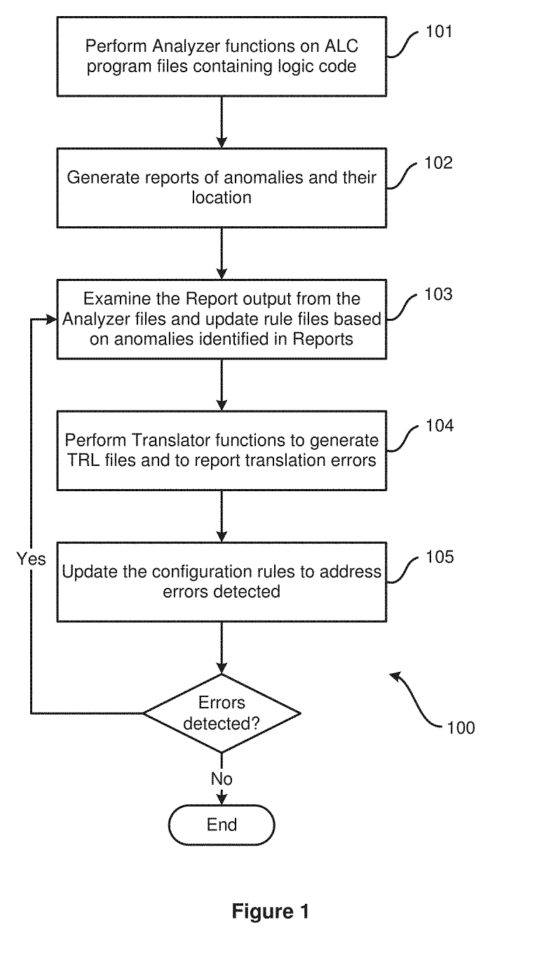

FIG. 1 is a flow chart of an exemplary TRL implementation method. TRL is a high level script/procedure language specially designed to capture ALC constructs and provide a separation between ALC data and program logic flows. The separation of data from logic code is critical to TRL. Translating ALC to TRL using the Analyzer Tool and Translator Tool is an iterative process. Initially all Configuration Files for the Analyzer and Translator Tools are empty.

Step 101 is the step of performing Analyzer functions on ALC program files containing logic code. The Analyzer Tool functions identify code structure and detect potential errors in files containing ALC logic code. In various embodiments, the ALC program files' sequential logical ALC instructions have been separated from data values,

Step 102 is the step of generating Reports of anomalies and their location. Examples of anomalies detected at this stage include auto-generated interface rules and auto-generated “looper” rules. In various embodiments, Reports may be generated to identify rules that are necessary to address constructs (if statements, for loops, and recursive code) that replace GOTO statements and branches to support flow control. Reports may further include information as to structures of detected and configured subroutines and Call Graphs of subroutines,

Step 103 is the step of iteratively examining the Report output from the Analyzer files and updating rule files based on anomalies identified in Reports. As anomalies are identified, Subject Matter Experts (SMEs) configure appropriate updated configuration rules to manually fix the issues.

Step 104 is the step of iteratively performing Translator functions to generate TRL files and to report translation errors. The Translator Tool functions run the configuration rules, which are stored in the Configuration Files.

Step 105 is the step of updating the configuration rules to address errors detected by the Translator functions. If the Translator Tool functions detect errors, the configuration files are updated with new configuration rules. Steps 103 through 105 are iteratively repeated until there are no errors.

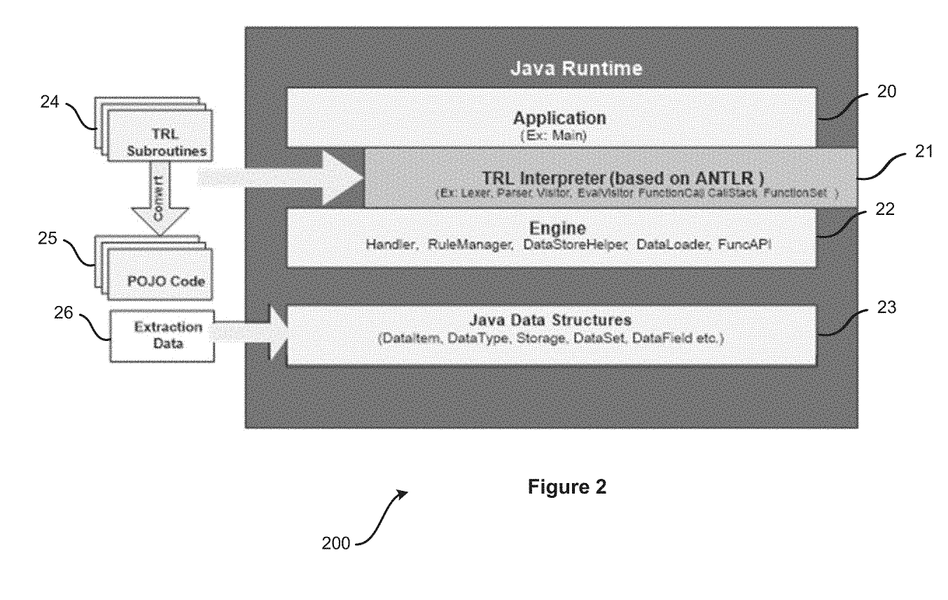

FIG. 2 is a schematic of an exemplary TRL Engine 200. In the embodiment shown, TRL Engine 200 allows verifying and executing TRL within a Java runtime environment. FIG. 2 depicts the layered application architecture of the TRL Engine 200 and its components, including Application layer 20, Interpreter 21, Engine 22, and Java data structures 23. Also visible in FIG. 2 are TRL subroutines 24 which convert to Plain Old Java Object (POJO) code 25. As shown in FIG. 2 Extraction Data 26 is used to populate Java data structures 23.

TRL is a full featured script programming language including constructs found in procedural language, such as PL/SQL, Pascal etc, allowing variable declaration, initialization, procedure calls and flow control features and more.

As illustrated in FIG. 2, the TRL Engine 200 requires two types of inputs to run: TRL subroutines 24 and Java Data Structures 23. Java data structures 23 include processing logic necessary obtain ALC to TRL translator results. Java data structures 23 include Java objects, such as DataItem, Storage, DataType, DataSet and DataField deserialized from data files from the Data Definition-Data extraction tool. As further illustrated in FIG. 2, each ALC listing is translated to a set of TRL files. Each TRL file consists of one or more TRL subroutines 24. In any given TRL file, only one subroutine is public, (i.e., it can be called by the subroutines in other TRL files). The rest of the subroutines are private, (i.e., they are only visible in the given TRL file).

In the exemplary embodiment shown, TRL Engine 200 contains several Java class implementations. Java class implementations evaluate every TRL rule and emulate and execute the most of the ALC commands (including 5 instruction types). Java class implementations perform data loading and manipulations by utility classes. Java class implementation functions include loading data dumps in the same format of binary byte data file for mainframe ALC run in TRL. This class implementation takes a “memory snapshot” of TRL execution at any timestamp for runtime data verifications. Still other Java class implementations used in TRL Engine 200 manage memory allocation, relocation and deallocation of data items.

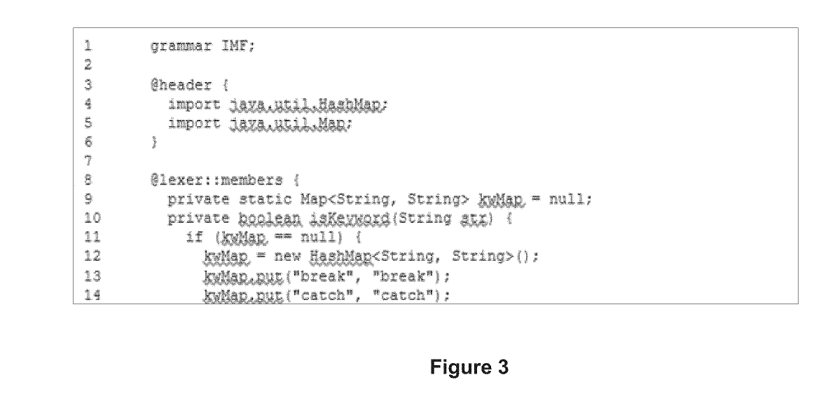

FIG. 3 illustrates an exemplary TRL code segment illustrating TRL grammar. The TRL language, as defined by the grammar, is a rule set which supports all the needs for the assembler translation with ALC data types including but not limited to int/Integer, float, Boolean/Boolean, String, list, AString, CString, PString, XString, etc.

In various embodiments, TRL grammar may utilize or adapt code and features from “parser tools” known in the art. A Parser tool is software which contains code for reading, processing, executing, or translating structured text or binary files. Parser tools provide functionality to developers for building languages.

An example of one parser tool known in the art is ANTLR (Another Tool for Language Recognition). ANTLR is an example of a parsing tool which has recognized features that may be utilized by TRL. ANTLR, or other parser tools, may be used to provide recognizable notations within the TRL grammar structure while enabling the addition of new features identified by TRL keywords.

In the exemplary embodiment shown, ANTLR is implemented by a parser generator that uses LL(*) parsing. The TRL interpreter allows interpreting TRL language within a Java runtime environment. The TRL interpreter is designed and implemented at the top of ANTLR. ANTLR takes as input a grammar that specifies a language and generates as output source code for a recognizer for that language. Given the grammar of a language such as TRL, ANTLR generates a lexer (or scanner) and parser for the language.

Parsers can automatically generate abstract syntax trees which can be further processed with tree parsers. ANTLR provides a single consistent notation for specifying lexers, parsers, and tree parsers.

As illustrated by the exemplary grammar shown in FIG. 3, ANTLR grammars always start with a grammar header. In the exemplary embodiment shown, this grammar is called IMF and must match the file name: IMF.g4. The grammar is called IMF because it is tailored to represent IMF programming logic in a high-level language, although the grammar is fairly generic and applicable to other ALC applications. The grammar is also extensible to include new features when needed. Lines 3-14, shown in FIG. 3, define a set of keywords reserved in TRL grammar. As in other high-level programming languages, these keywords should not be used as names of user-defined functions. The complete sample of the TRL grammar is provided in Appendix A.

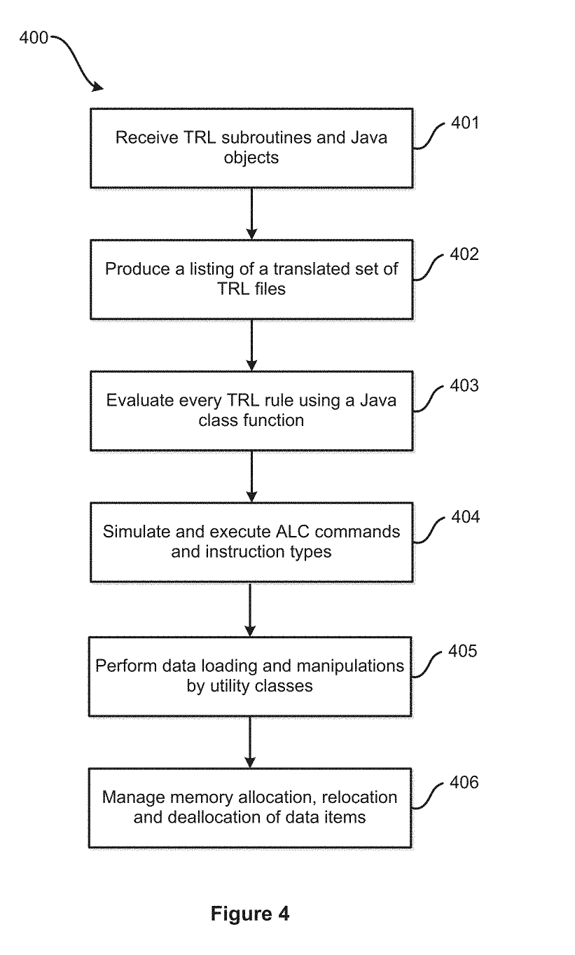

FIG. 4 illustrates an exemplary TRL Method 400 with subroutines.

Step 401 is the step of receiving TRL subroutines and Java objects. In the embodiment shown, TRL Engine 200 receives two types of inputs. First, TRL Engine 200 receives TRL subroutine/programs reflecting the processing logic obtained from ALC to TRL Translator functions. Second, TRL Engine 200 receives Extraction Data and Java Data Objects. In various embodiments, Java Data Objects and attributes may include Dataltem, Storage, DataType, DataSet and DataField deserialized from data files from the Data Definition resulting from Data Extraction Tool functions.

Step 402 is the step of producing a listing of a translated set of TRL files. Each TRL file consists of one or more subroutines. In any given TRL file only one subroutine is public (i.e., can be called by the subroutines in other TRL files). The rest of the subroutines are private (i.e., they are only visible in the given TRL file).

The TRL language, as defined by the grammar, supports all assembler translation with the following selective features:

A variety of ALC data types, such as int/Integer, float, Boolean/Boolean, String, list, AString, CString, PString, XString, etc.

All arithmetic operations, logical operations

Variable assignments

Built-in and customized functions

Function declaration and invoking

Control flow and decision statements

Variable scopes

Exception handling

Return, break statements

Step 403 is the step of evaluating every TRL rule using a Java class function.

Step 404 is the step of simulating and executing ALC commands and instruction types.

Step 405 is the step of performing data loading and manipulations by utility classes. This step includes loading data dump (the same format of binary byte data file for mainframe ALC run) in TRL Engine 200 and taking a memory snapshot of TRL execution at any timestamp for runtime data verifications

Step 406 is the step of managing memory allocation, relocation and deallocation of data items.

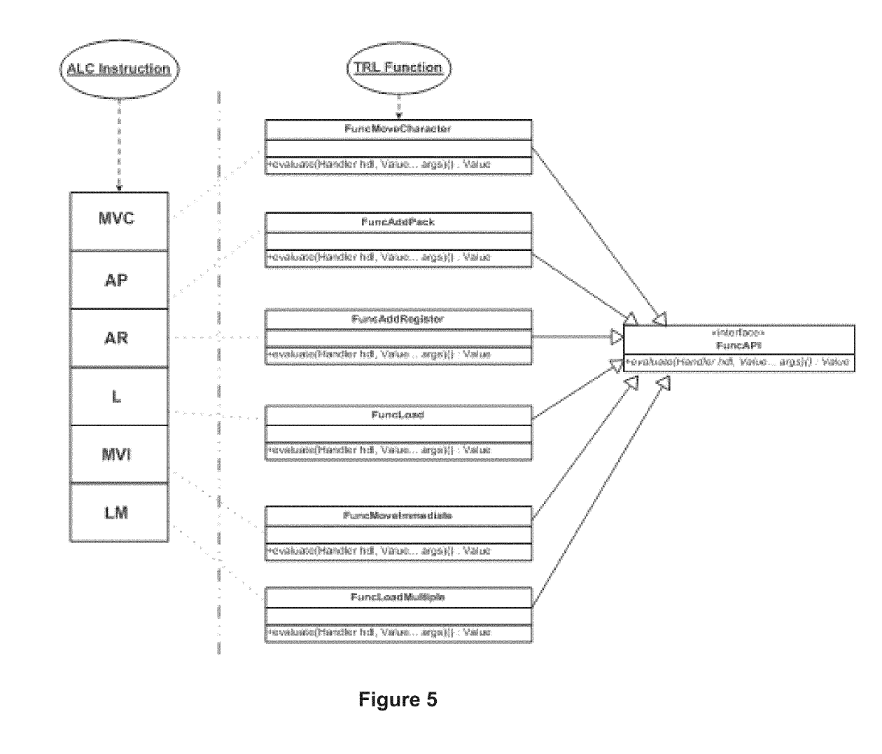

FIG. 5 illustrates an exemplary TRL function and ALC to TRL function map. As illustrated in FIG. 5, TRL provides a runtime environment over JVM as an emulator of ALC instruction commands. The emulator is implemented with a collection of Java classes. Every Java class in TRL does exactly what the corresponding ALC instruction does on a mainframe system. Currently, TRL supports a majority of mainframe instructions that make up a working subset of assembler language programs,

In the exemplary embodiment shown, there are 6 types of ALC instructions: SS1, SS2, RR, RX, SI, and RS, with a set of corresponding instructions. In the exemplary embodiment shown, the SS2 instruction type contains the following: AP, CP, DP, MVO, MP, PACK, SP, UNPK, ZAP etc,

FIG. 5 illustrates the mapping of representative ALC instructions to corresponding TRL functions. For example, the MVC of SS1 type instruction in ALC is associated with FuncMoveCharacter in TRL, whereas AP of SS2 type instruction has a Java class of FuncAddPack at TRL.

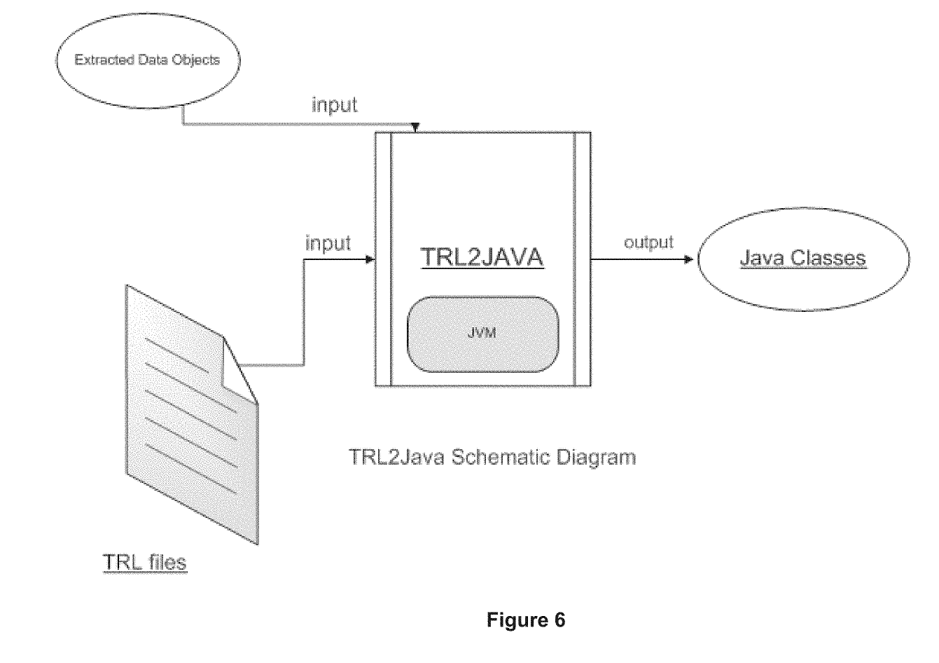

FIG. 6 is a conceptual illustration of TRL translation to Java Code. The exemplary TRL to Java translator illustrated in FIG. 6 receives inputs of extracted data objects and TRL files, and transforms them into Java classes. The output Java classes are shown in the class diagram in the figure below.

The TRL to Java Code Generator transforms the source TRL program into Java code which has the same external behavior (i.e., it is equivalent under a precisely defined denotational semantics). In various embodiments, the TRL to Java Code Generator refines the target Java code to confirm Java object-oriented design best practices.

As shown in FIG. 6, the first stage is data translation. Extracted data objects of CSECT data are deserialized from serialized data files to change the data representation and translated into an abstract base class which has an abstract method: public void evaluate( ) A CSECT is a block of coding that can be relocated (independent of other coding) without altering the operating logic of the program.

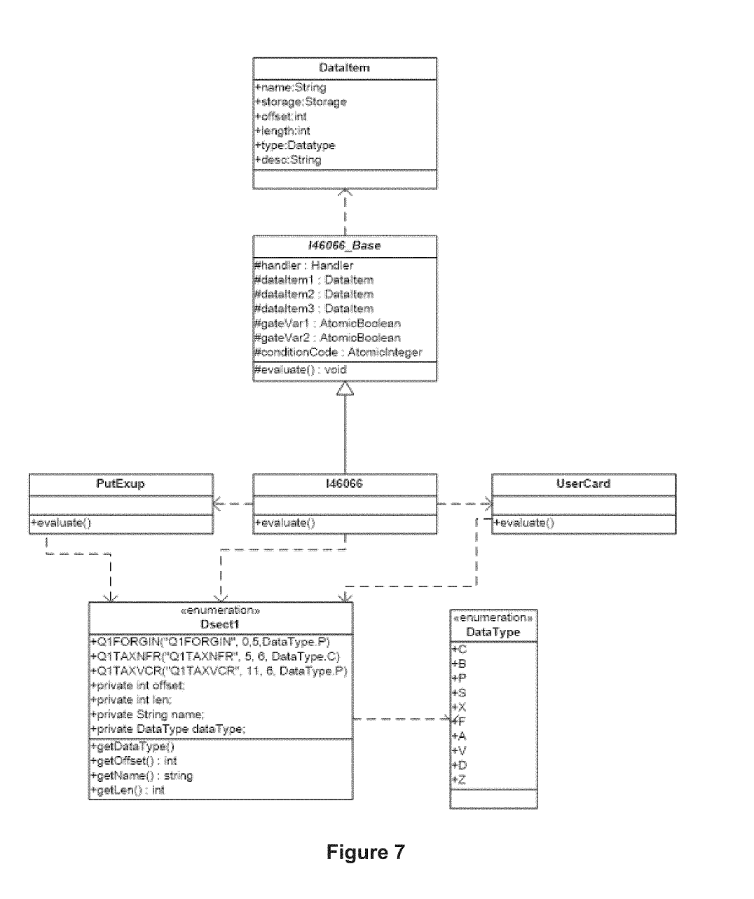

FIG. 7 illustrates the I46066 ALC program. All the data elements of CSECT data are placed in a base class of I46066_Base class. In addition, the base class has a Handler class as member, which is used to centrally manage other data resources such as condition code, flow control/self-modified variables for every CSECT. Every DSECT in I46066 is translated a Java Enum such as Dsect1, Dsect2 etc. A DSECT in ALC gives the layout of all data in that DSECT, so by making some reasonable assumptions about non-overlapping DSECTs. At run time, DSECT layout is assigned with values through base registers from memory based on the offset and length of containing Enum element in the DSECT.

In the exemplary embodiment shown, each TRL file (e.g., such as I46066.trl, UserCard.trl and PutExup.trl etc.) is translated into a concrete class by extending I46066_Base class and implementing the base class evaluate( ) method.

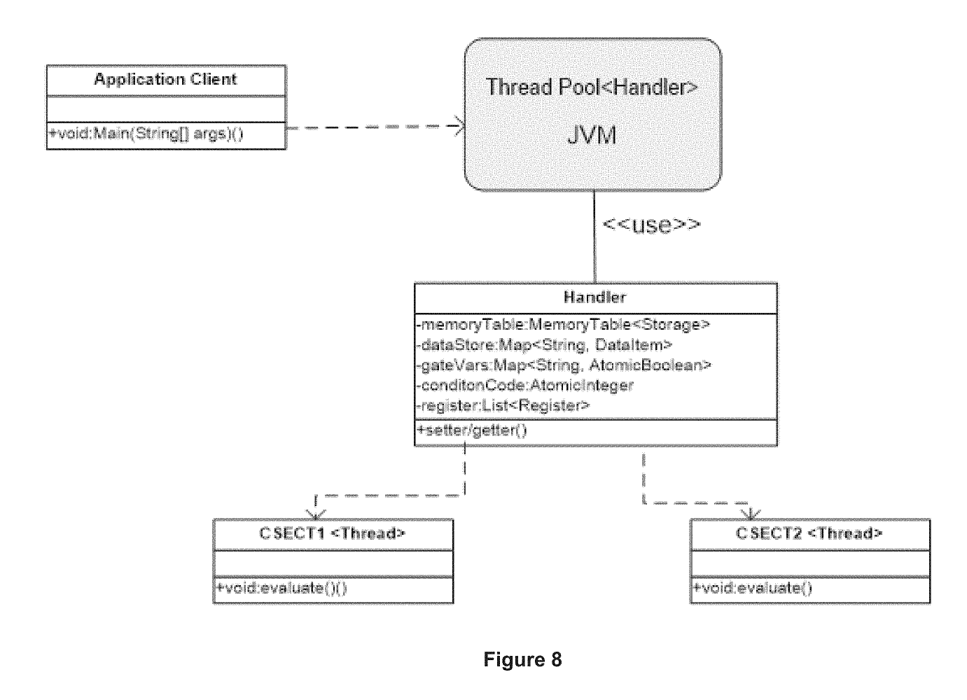

FIG. 8 is a diagram of a TRL to Java Class Multiple Thread Model. Legacy assembler programs have everything accessible in a global manner and are designed to execute in a sequential manner. Registers and data labels are modified everywhere in a program and/or even across different ALC modules through memory address access. Every instruction can frequently modify itself to have self-modifications which make ALC code difficult to debug.

The TRL to Java translation design enables translated Java classes to be executed based on a multithread model. Application performance is greatly improved with concurrent execution of numerous CSECTs. Additionally, for single CSECT input data set can be partitioned into a set of non-overlapping disjoined subsets, each of which can be processed well in parallel mode.

In the exemplary method shown in FIG. 8, a handler class is instantiated during translation manages and centralizes resources, including registers, data store containing CSECT data objects, flow control variables, storage for an entire CSECT and a memory tables containing any dynamic created storages. Each handler can be maintained in a Thread Local, and managed in a thread pool. Application client creates and instantiates a configurable number of Handler instances, which is fed into the translated based classes. Depending on the translated ALC programs, the results of executing the translated application concurrently might be consolidated and aggregated to meet business needs.

Data and business logic are translated. The data objects from the extraction tool can be easily migrated from one type of data structure in mainframe to Java object oriented, whereas business logic in TRL programs are a complete line to line translation from one format to another. This translated target data/structure and process logic can be traced and verified separately.

Using ANTLR makes the translation process easier to manage and verify—throughout the translation process, a simple ANTLR grammar file has been created and utilized to describe syntaxes required for translation. This makes any syntax change to have different representations much simpler. This feature is also beneficial to trace back from target Java code to intermediate TRL, then to original ALC, by generating a document with generated code.

The benefit of separating data from processing logic in translation—translation works by translating data and business logic separately in the tool, although this is transparent to the end users. The data objects from the extraction tool can be easily migrated from one type of data structure in mainframe to Java object oriented, whereas business logic in TRL programs are a complete line to line translation from one format to another. This translated target data/structure and process logic can be traced and verified separately.

Using ANTLR makes the translation process easier to manage and verify—throughout the translation process, a simple ANTLR grammar file has been created and utilized to describe syntaxes required for translation. This makes any syntax change to have different representations much simpler. This feature is also beneficial to trace back from target Java code to intermediate TRL, then to original ALC, by generating a document with generated code.

What is claimed is:

1. A method for translating ALC to TRL comprised of the steps of;
analyzing ALC data program flows;
parsing ALC data and logic code to create at least one Java Data Object and at least one sequential set of ALC instructions from which a graphical representation can be created; and
translating ALC logic code to TRL by iteratively performing the following steps until no translation errors are detected:
translating graphically represented patterns,
applying configuration rules,
generating reports of unhandled code, and
updating said configuration rules

2. The method of claim 1 which includes the step of generating reports of rules to ALC code attributes, wherein said code attributes are selected from a group consisting of: if statements, for loops, recursive code, GOTO statements and branches.

3. The method of claim 1 which further includes the step of receiving TRL subroutines Java Data Objects.

4. The method of claim 1 which further includes producing a listing of a translated set of TRL files.

5. The method of claim 1 wherein every TRL rule is evaluated using a Java class function.

6. The method of claim 1 which further includes loading a data dump and performing runtime data verification.

7. The method of claim 1 which further includes receiving inputs of extracted data objects and TRL files, and transforming said extracted data objects and said TRL files into Java classes.

8. The method of claim 1 which further includes the step of tracking the execution path of said TRL files and comparing execution path to the source ALC.

9. The method of claim 1 wherein said ALC files are IMF ALC files.

10. A computer processing apparatus for executing TRL comprised of:
a plurality of TRL files containing one or more subroutine inputs; and
an interface for receiving one or more Java data structure inputs.

11. The computer processing apparatus of claim 10 wherein said Java data structures are Java objects selected from a group consisting of DataItem, Storage, DataType, DataSet and DataField deserialized files.

12. The computer processing apparatus of claim 10 wherein each of said TRL files includes only one public subroutine which can be called by the subroutines in other TRL files.

13. The computer processing apparatus of claim 10 which further includes multiple Java class implementations.

14. The computer processing apparatus of claim 13 wherein said Java class implementations include functions for performing data dumps in the same format of binary byte data file for mainframe ALC run in a in TRL.

15. The computer processing apparatus of claim 13 wherein said Java class implementations include functions for evaluating every TRL rules to emulate ALC commands.

16. The computer processing apparatus of claim 10 which further includes functions to perform runtime data verifications.

17. The computer processing apparatus of claim 10 which utilizes TRL grammar.

18. The computer processing apparatus of claim 17 wherein said TRL grammar utilized one or more features of a parsing tool.

19. The computer processing apparatus of claim 10 which father includes functions to run multiple threads.

20. The computer processing apparatus of claim 10 which further includes a TRL to Java Class Multiple Thread Model.
